(19) United States
(12) Patent Application Publication
(10) Pub. No.: US 2023/0413723 A1
(43) Pub. Date: Dec. 28, 2023

(54) Weed Removal Tool

(71) Applicants: Mike Sedleski, Winnepeg (CA); Shauna Sedleski, Winnepeg (CA)

(72) Inventors: Mike Sedleski, Winnepeg (CA); Shauna Sedleski, Winnepeg (CA)

(21) Appl. No.: 17/846,236

(22) Filed: Jun. 22, 2022

(51) Int. Cl. A01D 1/08

(52) U.S. Cl. CPC A01D 1/08

(57) ABSTRACT

A weed removal tool for removing dandelions and other weeds without creating hazardous divots in the ground, without spreading seeds, and without the use of chemicals includes a handle that is elongated along a longitudinal axis and a tool head coupled to and extending away from the handle in a direction parallel to the longitudinal axis. The tool head has a blade section extending from a back end to a front edge and a pair of lateral edges extending from the back end to the front edge. The lateral edges are coplanar with each other. The blade section has a notch in the front edge.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to weed removal tools and more particularly pertains to a new weed removal tool for removing dandelions and other weeds without creating hazardous divots in the ground, without spreading seeds, and without the use of chemicals.

### (2) Description of Related Art Including Information Disclosed under 37 CFR 1.97 and 1.98

The prior art primarily relates to weed removal tools that resort to pulling, prying, or cutting dandelions and other weeds at the root. This approach to weed removal is prone to leaving divots in the ground which pose a hazard to pets and humans walking in the area. The prior art also relates to weed removal tools that cut above the root, but the disclosed approach features a bulky design with several components which is to be used by dragging along the ground and is intended primarily for collecting a quantity of dandelions for the purposes of making dandelion wine. The prior art does not relate to a weed removal tool that cuts above the root using a lightweight design with minimal components optimal for removing a relatively small number of dandelions or other weeds at one time.

### BRIEF SUMMARY OF THE INVENTION

An embodiment of the disclosure meets the needs presented above by generally comprising a handle that is elongated along a longitudinal axis and a tool head coupled to and extending away from the handle in a direction parallel to the longitudinal axis. The tool head has a blade section extending from a back end to a front edge and a pair of lateral edges extending from the back end to the front edge. The lateral edges are coplanar with each other. The blade section has a notch in the front edge.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a weed removal tool according to an embodiment of the disclosure.

FIG. 2 is a side view of an embodiment of the disclosure.

FIG. 3 is a top view of an embodiment of the disclosure.

FIG. 4 is an in-use view of an embodiment of the disclosure.

### DETAILED DESCRIPTION OF THE INVENTION

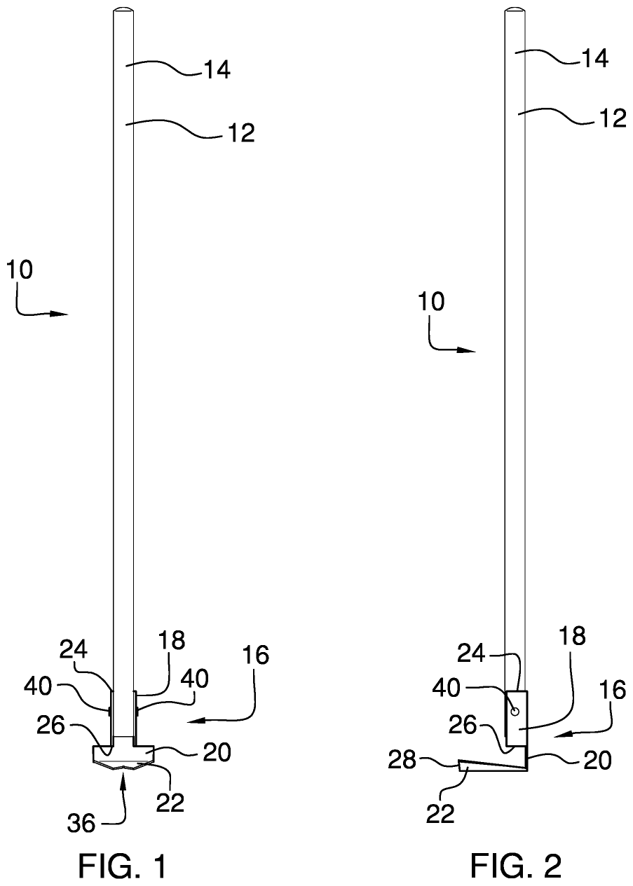

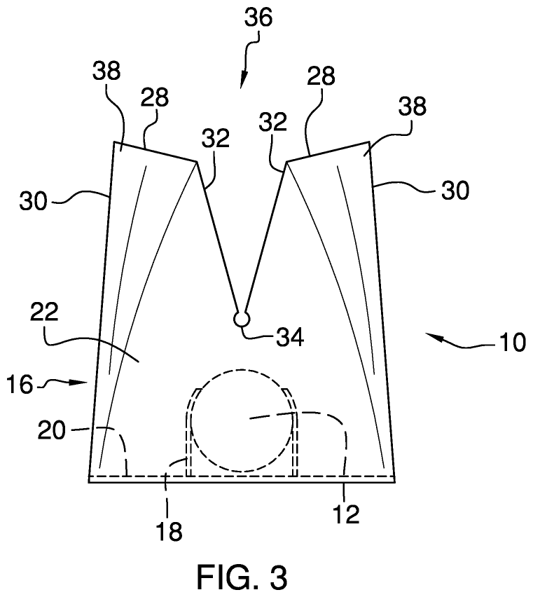

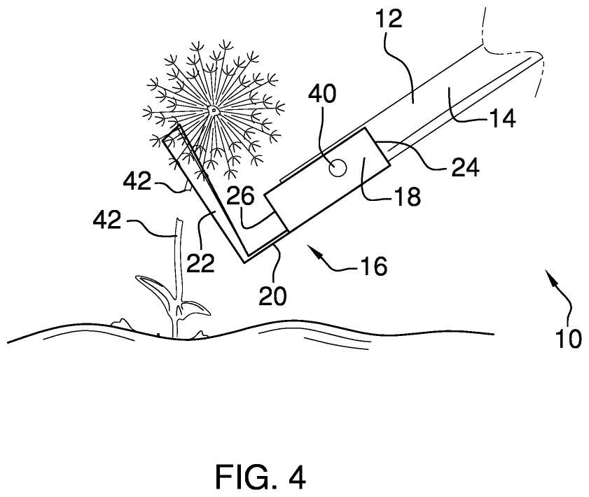

With reference now to the drawings, and in particular to FIGS. 1 through 4 thereof, a new weed removal tools embodying the principles and concepts of an embodiment of the disclosure and generally designated by the reference numeral 10 will be described.

As best illustrated in FIGS. 1 through 6, the weed removal tool 10 generally comprises a cylindrical handle 12 that is elongated along a longitudinal axis, wherein the handle 12 has a diameter 14 between 3.0 and 4.0 centimeters and a length between 71.0 centimeters and 89.0 centimeters. A tool head 16 includes an attachment section 18, an extension section 20, and a blade section 22. The attachment section 18 is coupled to the handle 12 and has a length from a first end 24 of the attachment section 18 to a second end 26 of the attachment section 18 between 8.0 and 9.0 centimeters. The attachment section 18 has an inner surface abutting a lateral surface of the handle 12, and a portion of the attachment section 18 extends past an end of the handle 12 in a direction parallel to the longitudinal axis. The extension section 20 extends from the attachment section 18 in a direction parallel to the longitudinal axis at a length between 2.0 and 3.0 centimeters and has a width between 7.0 and 8.0 centimeters.

The blade section 22 extends along a central axis that is perpendicular to the longitudinal axis from the extension section 20 to a front edge 28 of the blade section 22 at a length between 6.0 and 7.0 centimeters. The blade section 22 also has a pair of lateral edges 30 extending from the extension section 20 to the front edge 28 which are coplanar with each other. The blade section 22 has a pair of linear edges 32 and a curved edge 34 defining a notch 36. Each linear edge 32 extends from the curved edge 34 to the front edge 28 at a length between 3.7 centimeters and 3.9 centimeters. The curved edge 34 has a center point along the central axis and has a radius between 0.1 centimeters and 0.2 centimeters. The curved edge 34 is configured to fit around a dandelion stem 42. The front edge 28 has a pair of angled portions 38 which extend from an associated one of the pair of linear edges 32 away from the central axis to an associated one of the pair of lateral edges 30. A plane lies orthogonal to the longitudinal axis and coplanar with the linear edges 32. Each angled portion 38 extends from each associated one of the pair of linear edges 32 to the associated one of the pair of lateral edges 30 at a 20.0-degree angle from the plane toward the handle 12. Each of a plurality of screws 40 extend through the attachment section 18 of the tool head 16 and through the lateral surface of the handle 12, securing the tool head 16 to the handle 12.

In use, a user holds the handle 12 with the tool head 16 positioned near a ground surface. Then, the user lightly swings the removal tool 10 or kicks the tool head 16 such that the blade section 22 of the tool head 16 abruptly strikes the dandelion stem 42 with the dandelion stem 42 positioned within the notch 36. In so doing, the tool head 16 cuts the dandelion stem 42 at the place of contact and contains the cut portion of the dandelion stem 42 within the curved edge 34 of the notch 36, the head of the dandelion being positioned between the blade section 22 of the tool head 16 and the handle 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A weed removal tool comprising:
a handle being elongated along a longitudinal axis; and
a tool head coupled to and extending away from said handle in a direction parallel to said longitudinal axis, said tool head having a blade section,
wherein said blade section extends from a back end to a front edge, said blade section having a pair of lateral edges extending from said back end to said front edge, said lateral edges being coplanar with each other,
wherein said blade section has a notch in said front edge.

2. The device of claim 1, wherein said handle is cylindrical, said handle having a diameter between 3.0 and 4.0 centimeters.

3. The device of claim 1, wherein said handle has a length between 71.0 centimeters and 89.0 centimeters.

4. The device of claim 1, wherein said tool head has an attachment section and an extension section,
wherein said attachment section is coupled to said handle, wherein a portion of said attachment section extends past an end of said handle in a direction parallel to said longitudinal axis,
wherein said extension section extends from said attachment section in a direction parallel to said longitudinal axis.

5. The device of claim 4, wherein said attachment section has a length from said first end of said attachment section to said second end of said attachment section between 8.0 and 9.0 centimeters.

6. The device of claim 4, further comprising a plurality of screws, wherein said attachment section has an inner surface abutting a lateral surface of said handle, each said screw extending through said attachment section of said tool head and through said lateral surface of said handle, said plurality of screws securing said tool head to said handle.

7. The device of claim 4, wherein said extension section extends from said attachment section at a length between 2.0 and 3.0 centimeters.

8. The device of claim 4, wherein said extension section has a width between 7.0 and 8.0 centimeters.

9. The device of claim 1, wherein said blade section has a length from said back end to said front edge between 6.0 and 7.0 centimeters. The device of claim 1, wherein said notch comprises a pair of linear edges and a curved edge, each said linear edge extending from said curved edge to said front edge.

11. The device of claim 10, wherein each said linear edge has a length between 3.7 centimeters and 3.9 centimeters.

12. The device of claim 10, wherein said curved edge has a radius between 0.1 centimeters and 0.2 centimeters, said curved edge being configured to fit around a dandelion stem.

13. The device of claim 1, wherein said front edge has a pair of angled portions, each angled portion extending from an associated one of said pair of linear edges away from said central axis to an associated one of said pair of lateral edges, wherein each said angled portion extends from each said associated one of said pair of linear edges to said associated one of said pair of lateral edges angled toward said handle.

14. The device of claim 13, wherein a plane lies orthogonal to said longitudinal axis and coplanar with said linear edges, wherein each said angled portion extends from each said associated one of said pair of linear edges to said associated one of said pair of lateral edges at a 20.0-degree angle from said plane toward said handle

15. A weed removal tool comprising:
a cylindrical handle being elongated along a longitudinal axis, said handle having a diameter between 3.0 and 4.0 centimeters and a length between 71.0 centimeters and 89.0 centimeters;
a tool head including an attachment section, an extension section, and a blade section,
wherein said attachment section is coupled to said handle and has a length from a first end of said attachment section to a second end of said attachment section between 8.0 and 9.0 centimeters, said attachment section having an inner surface abutting a lateral surface of said handle, wherein a portion of said attachment section extends past an end of said handle in a direction parallel to said longitudinal axis,
wherein said extension section extends from said attachment section in a direction parallel to said longitudinal axis at a length between 2.0 and 3.0 centimeters, said extension section having a width between 7.0 and 8.0 centimeters,
wherein said blade section extends along a central axis that is perpendicular to said longitudinal axis from said extension section to a front edge of said blade section at a length between 6.0 and 7.0 centimeters, said blade section having a pair of lateral edges extending from said extension section to said front edge, said lateral edges being coplanar with each other,
wherein said blade section has a pair of linear edges and a curved edge defining a notch, each said linear edge extending from said curved edge to said front edge, each said linear edge having a length between 3.7 centimeters and 3.9 centimeters, said curved edge having a center point along said central axis and having a radius between 0.1 centimeters and 0.2 centimeters, said curved edge being configured to fit around a dandelion stem,
wherein said front edge has a pair of angled portions, each angled portion extending from an associated one of said pair of linear edges away from said central axis to an associated one of said pair of lateral edges, wherein a plane lies orthogonal to said longitudinal axis and coplanar with said linear edges, wherein each said angled portion extends from each said associated one of said pair of linear edges to said associated one of said pair of lateral edges at a 20.0-degree angle from said plane toward said handle; and
a plurality of screws, each said screw extending through said attachment section of said tool head and through said lateral surface of said handle, said plurality of screws securing said tool head to said handle.
